(19) United States
(12) Patent Application Publication
(10) Pub. No.: US 2002/0091725 A1
(43) Pub. Date: Jul. 11, 2002

(54) METHOD AND APPARATUS FOR PROVIDING CLIENT-BASED WEB PAGE CONTENT CREATION AND MANAGEMENT

(76) Inventor: DAVID SKOK, LINCOLN, MA (US)

Correspondence Address: THE HECKER LAW GROUP, 1925 CENTURY PARK EAST, SUITE 2300, LOS ANGELES, CA, 90067, US

(21) Appl. No.: 09/076,923

(22) Filed: May 12, 1998

(51) Int. Cl. G06F 15/00

(52) U.S. Cl. 707/501.1

(57) ABSTRACT

The present invention provides a system that permits bidirectional collaboration and contribution by a consumer or reader to richly formatted web documents and database records containing fields with richly formatted content. The invention permits participation in both the content creation and content management cycle. The invention provides content data in a database that includes HTML portions and file attachments or objects. These objects can include jpeg files, gif files, xcel, sound, avi, quicktime and other file types. The invention also provides a method of specifying and tracking attributes associated with the document. There are two classes of attributes in the invention. One class includes data such as who created a document or portion of document, who approved a document and when it was approved. The second class of attributes includes subject, category, and other data that can be used to provide automatic indexing of data. Client based content creation is accomplished in one embodiment by applet based HTML edit controls, and the use of attachment databases to allow manipulation of attachments with respect to the HTML document. The invention also provides a method for dynamically updating or adding links on pages that are used to help users navigate a web site.

### BACKGROUND OF THE INVENTION

1. Field of the Invention

This invention relates to the field of creating, editing and maintaining, digital and electronic documents.

2. Background Art

The Internet, or World Wide Web, is used extensively to access information from a variety of sources. A disadvantage with the Internet is the fact that the information is only for reading. It is not currently easy to create and/or edit information on the Internet. This problem can be better understood by first reviewing the Internet and the way it operates.

### The Internet

The Internet is a worldwide matrix of interconnected computers. An Internet client accesses a computer on the network via an Internet provider. An Internet provider is an organization that provides a client (e.g., an individual or other organization) with access to the Internet (via analog telephone line or Integrated Services Digital Network line, for example). A client can, for example, read information from, download a file from or send an electronic mail message to another computer/client using the Internet.

To retrieve a file on the Internet, a client must search for the file, make a connection to the computer on which the file is stored, and download the file. Each of these steps may involve a separate application and access to multiple, dissimilar computer systems. The World Wide Web (WWW) was developed to provide a simpler, more uniform means for accessing information on the Internet.

The components of the WWW include browser software, network links, and servers. The browser software, or browser, is a user-friendly interface (i.e., front-end) that simplifies access to the Internet. A browser allows a client to communicate a request without having to learn a complicated command syntax, for example. A browser typically provides a graphical user interface (GUI) for displaying information and receiving input. Examples of browsers currently available include Mosaic, Netscape, Microsoft Internet Explorer, and Cello.

Information servers maintain the information on the WWW and are capable of processing a client request. Hypertext Transport Protocol (HTTP) is the standard protocol for communication with an information server on the WWW. HTTP has communication methods that allow clients to request data from a server and send information to the server.

To submit a request, the client contacts the HTTP server and transmits the request to the HTTP server. The request contains the communication method requested for the transaction (e.g., GET an object from the server or POST data to an object on the server). The HTTP server responds to the client by sending a status of the request and the requested information. The connection is then terminated between the client and the HTTP server.

A client request therefore, consists of establishing a connection between the client and the HTTP server, performing the request, and terminating the connection. The HTTP server does not retain any information about the request after the connection has been terminated. HTTP is, therefore, a stateless protocol. That is, a client can make several requests of an HTTP server, but each individual request is treated independent of any other request. The server has no recollection of any previous request.

An addressing scheme is employed to identify Internet resources (e.g., HTTP server, file or program). This addressing scheme is called Uniform Resource Locator (URL). A URL contains the protocol to use when accessing the server (e.g., HTTP), the Internet domain name of the site on which the server is running, the port number of the server, and the location of the resource in the file structure of the server.

The WWW uses a concept known as hypertext. Hypertext provides the ability to create links within a document to move directly to other information. To activate the link, it is only necessary to click on the hypertext link (e.g., a word or phrase). The hypertext link can be to information stored on a different site than the one that supplied the current information. A URL is associated with the link to identify the location of the additional information. When the link is activated, the client's browser uses the link to access the data at the site specified in the URL.

If the client request is for a file, the HTTP server locates the file and sends it to the client. An HTTP server also has the ability to delegate work to gateway programs. The Common Gateway Interface (CGI) specification defines the mechanisms by which HTTP servers communicate with gateway programs. A gateway program is referenced using a URL. The HTTP server activates the program specified in the URL and uses CGI mechanisms to pass program data sent by the client to the gateway program. Data is passed from the server to the gateway program via command-line arguments, standard input, or environment variables. The gateway program processes the data and returns its response to the server using CGI (via standard input, for example). The server forwards the data to the client using the HTTP.

A browser displays information to a client/user as pages or documents (referred to as “web pages” or “web sites”). A language is used to define the format for a page to be displayed in the WWW. The language is called Hypertext Markup Language (HTML). A WWW page is transmitted to a client as an HTML document. The browser executing at the client parses the document and produces a displays a page based on the information in the HTML document.

HTML is a structural language that is comprised of HTML elements that are nested within each other. An HTML document is a text file in which certain strings of characters, called tags, mark regions of the document and assign special meaning to them. These regions are called HTML elements. Each element has a name, or tag. An element can have attributes that specify properties of the element. Blocks or components include unordered list, text boxes, check boxes, radio buttons, for example. Each block has properties such as name, type, and value. The following provides an example of the structure of an HTML document:

<HTML>

<HEAD>
. . . element(s) valid in the document head
</HEAD>
<BODY >
. . . element(s) valid in the document body
</BODY>

</HTML>

Each HTML element is delimited by the pair of characters “<” and “>”. The name of the HTML element is contained within the delimiting characters. The combination of the name and delimiting characters is referred to as a marker, or tag. Each element is identified by its marker. In most cases, each element has a start and ending marker. The ending marker is identified by the inclusion of an another character, “/” that follows the “<” character.

HTML is a hierarchical language. With the exception of the HTML element, all other elements are contained within another element. The HTML element encompasses the entire document. It identifies the enclosed text as an HTML document. The HEAD element is contained within the HTML element and includes information about the HTML document. The BODY element is contained within the HTML. The BODY element contains all of the text and other information to be displayed. Other HTML elements are described in HTML reference manuals.

### Publishing on the Internet

Publishing a web page is currently a one-way operation. The creator of a web page first uses document creation software, such as text editors, graphics tools, sound tools, etc. to create a document. The web page is then presented to a “web master” (a person that maintains a web site) who then prepares the original document for publishing on the web. This consists of the following steps:

1. Convert the document to HTML.

2. Place the HTML document on a web site.

3. Create a pointer or link to the document.

4. Create a full text index for access searches.

5. Maintain version history of changes.

6. Secure back-up of the document.

1. Convert the document to HTML. As noted above, the language used to define the format for a page to be displayed in the web is HTML. The web master (or the author) converts the source data to HTML data. (Note that it is also possible to create the source data in HTML originally).

2. Place the document on a web site. The involves storing the HTML document on the server that maintains the information on the web site on which the document is to be displayed.

3. Create a pointer or link to the document. This allows third party users to navigate to the page on the web site. The link may be on another page of the same web site, as well as on other web sites.

4. Create a full text index for access searches. This step as well as the following steps, are optional but desired. This step involves making the document searchable by providing a full or partial text index to the document.

5. Maintain version history of changes. A log of changes (along with the date and time of changes) is maintained so that evolution of the document can be tracked.

6. Secure back-up of the document. Regular offsite back-up of the document is maintained so that if there is a system failure, the document can be easily replaced or recreated.

FIG. 2 illustrates the current relationship of web components as they relate to publishing. Authors 206 prepare documents for publishing on the web and store the document to a document server 205. A web master 204 reviews the documents for approval for publishing. The web master 204 translates the documents to HTML if they are not already in that format, and copies the HTML versions to the Web server 203. The web master 204 also creates the necessary links to point to the new documents. The documents are accessed by read only consumers 201 through the internet (or intranet) 202.

### Content Management

In some institutional environments, approval procedures are required prior to publishing a web document. First the document is authored, then the document is reviewed by some entity, either an individual or a group, referred to as a web master. This process is sometimes collaborative with the author, and appropriate changes are made to the document. The document is then submitted to an approval entity, which may be the same or different from the review entity, and if approved, the document is ready for publishing. It is desired in the approval process to track who was involved in the review and approval process, as well as the various versions of the document that are created during the review and approval process.

Furthermore, content management often requires that documents have attributes associated with them. There are two classes of attributes that might be used. One class includes data such as who created a document or portion of document, who approved a document and when it was approved. The second class of attributes includes subject, category, and other data that can be used to categorize and index the documents. As an example consider a web site that is used to store documents about customers. For each customer there will be a richly formatted document describing that customer. However the document would also have attributes of Customer ID, Customer Name, and other attributes.

### Disadvantages of Prior Art

A disadvantage of the current process for publishing a document on the web is that it is a one way process. The consumer of information does not have the ability to react to reading a document and bi-directionally become a contributor to the document or web site that contains the document. There are no systems in place that allow collaboration on the web-using richly formatted HTML content, such as can be found with collaboration products currently available, such as Lotus Notes.

There have been some prior art attempts to provide bi-directionality on the web. One such attempt is found in Netscape Composer, which is part of the Netscape Navigator web browser. One key disadvantage of this approach is that it requires that the user have the Netscape composer software installed on their machine. Users of other browsers would not be able to edit these documents. This breaks a tenet of the World Wide Web, which is that all functionality should be available to all users no matter what web browser they use.

A second disadvantage of this prior art system is shown in FIGS. 3A and 3B which illustrate the operation of this prior art system where both structured data and richly formatted HTML content are combined in one document. In FIG. 3A, a form 301 is shown displayed in the display space of a browser window. The form is comprised of a form layout and form content, contained in a single HTML document. the form represents the layout and look of the document. The content is actual data that appears in desired locations within the forms, that is, the data that fills in the blanks of the form. For example, the form includes a “Company” line 302 on the form, a “Phone No:” line 303 and a “Company Description” line 305. These lines are followed by data, namely “Acme Corporation” on the company line, “617-555-2358” on the phone number line, and a richly formatted description of the company under the heading Company Description. It is desirable that the user should be able to edit both the simple structured fields of Company and Phone No. as well as the richly formatted Company Description field. FIG. 3A shows the simple structured fields as being editable, but not the richly formatted field for Company Description. This is because of a fundamental shortcoming in the specification of HTML form controls. While there are HTML form controls for editing simple text with a single font, there is no control for editing richly formatted HTML content.

Referring now to FIG. 3B, the document of FIG. 3A is shown in the display 304 of the Netscape Composer HTML page editor which a user might use in an attempt to edit the richly formatted HTML content. In this mode, the richly formatted text for Company Description is now editable but the structured data fields of Company Name and Phone no that were displayed in FIG. 3A are no longer visible. Furthermore the layout of the form itself is also editable, which is clearly not the intention. It is only the data in the three fields that should be editable.

In an attempt to get around this problem, other prior art systems such as Lotus Domino allow the editing of the field Company Description using a standard HTML control for text entry. This approach shown in FIG. 3C The disadvantage of this prior art is that there is no rich HTML formatting available while editing that field. The HTML text entry control only permits the use of a single font, and does not allow any formatting such as bold, italics, headings, tables, graphics, links, etc. The user may enter formatting by inserting HTML tags manually, but this process is extremely tedious, and does not easily permit the insertion of graphics.

In the example of Netscape Composer shown in Figure-3B, there is no change management or version management provided. The user makes changes and uploads the changed document to a web server, or commits changes to a document on a web server, without a history of changes and approval.

### SUMMARY OF THE INVENTION

The present invention provides a system that permits bi-directional collaboration and contribution by a consumer or reader to richly formatted web documents and database records containing fields with richly formatted content. The invention permits participation in both the content creation and content management cycle. The invention provides content data in a database that includes HTML portions and file attachments or objects. These objects can include jpeg files, gif files, xcel, sound, avi, quicktime and other file types. The invention also provides a method of specifying and tracking attributes associated with the document. There are two classes of attributes in the invention. One class includes data such as who created a document or portion of document, who approved a document and when it was approved. The second class of attributes includes subject, category, and other data that can be used to provide automatic indexing of data. Client based content creation is accomplished in one embodiment by applet based HTML edit controls, and the use of attachment databases to allow manipulation of attachments with respect to the HTML document. The invention also provides a method for dynamically updating or adding links on pages that are used to help users navigate a web site.

### BRIEF DESCRIPTION OF THE DRAWINGS

FIG. 1 illustrates an example computer system for implementing the present invention.

FIG. 2 illustrates the relationship between components of the web.

FIGS. 3A, 3B, and 3C illustrate an example of a prior art editing process.

FIG. 4 illustrates the topology of the consumer/author/web relationship in the present invention.

FIG. 5 is a flow diagram of the authorization process of the invention.

FIG. 6 is a flow diagram of the editing process of the invention.

FIG. 7 illustrates the content database of one embodiment of the invention.

### DETAILED DESCRIPTION OF THE INVENTION

The invention is a method and apparatus for providing content creation and management. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

### Embodiment of Computer Execution Environment (Hardware)

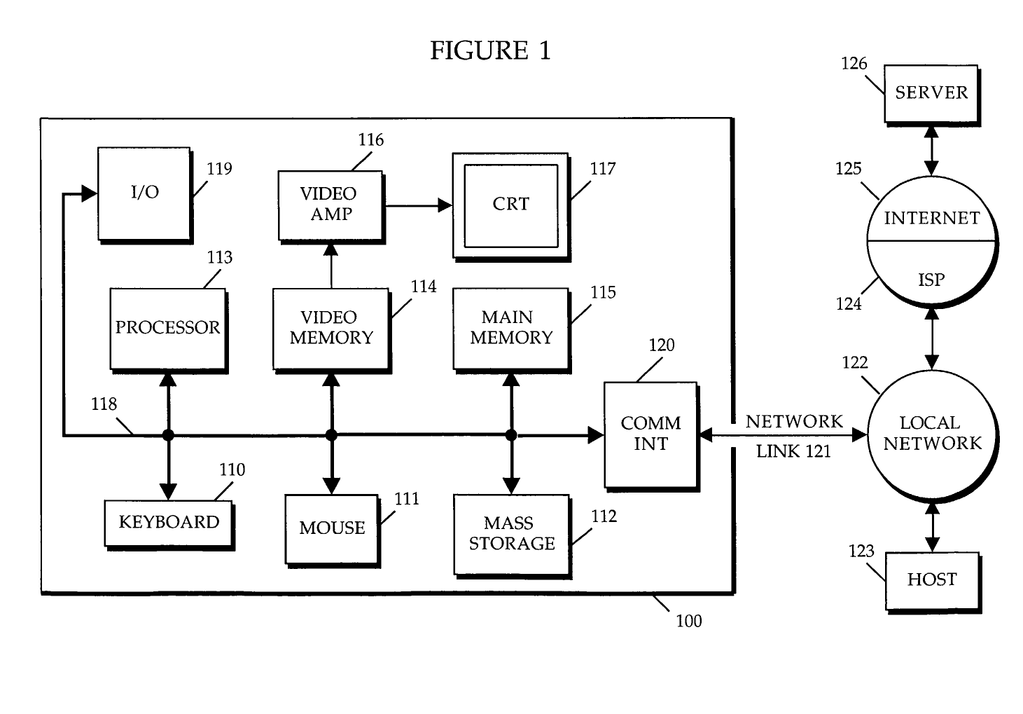

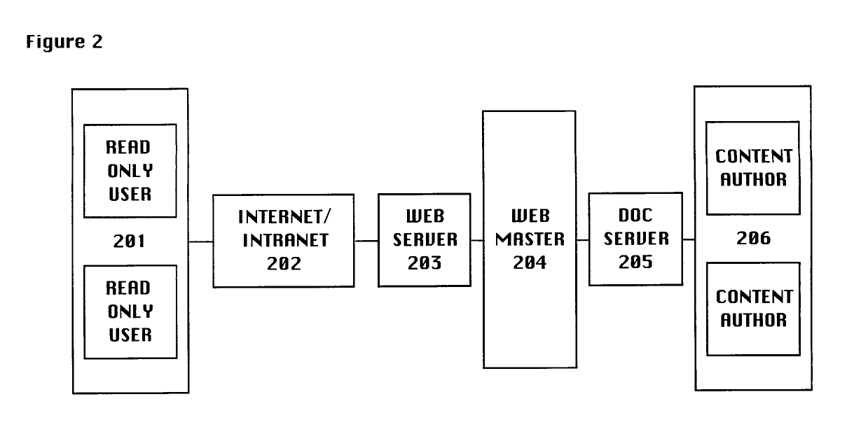

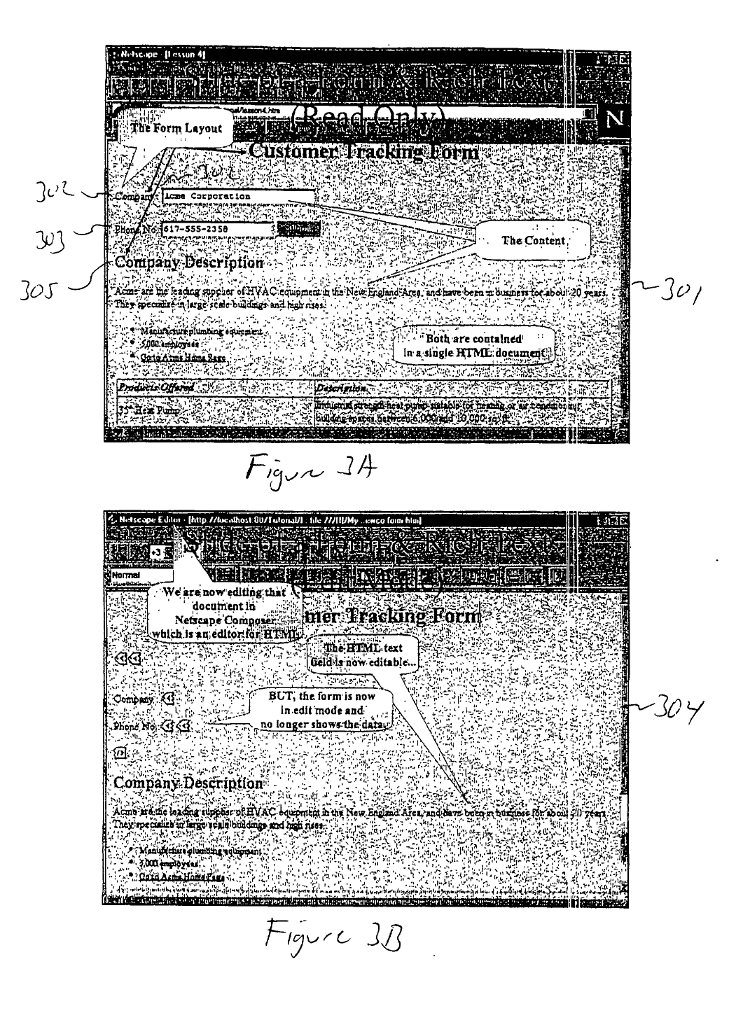

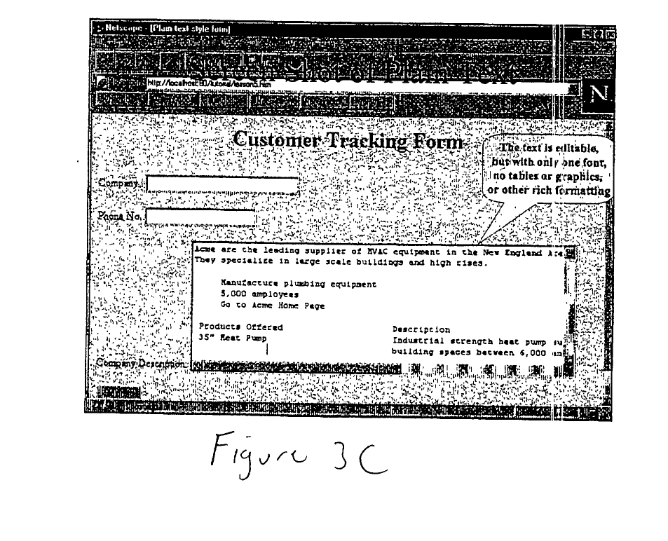

An embodiment of the invention can be implemented as computer software in the form of computer readable code executed on a general purpose computer such as computer 100 illustrated in FIG. 1, or in the form of bytecode class files executable within a Java™ runtime environment running on such a computer. A keyboard 110 and mouse 111 are coupled to a bi-directional system bus 118. The keyboard and mouse are for introducing user input to the computer system and communicating that user input to processor 113. Other suitable input devices may be used in addition to, or in place of, the mouse 111 and keyboard 110. I/O (input/output) unit 119 coupled to bi-directional system bus 118 represents such I/O elements as a printer, A/V (audio/video) I/O, etc.

Computer 100 includes a video memory 114, main memory 115 and mass storage 112, all coupled to bi-directional system bus 118 along with keyboard 110, mouse 111 and processor 113. The mass storage 112 may include both fixed and removable media, such as magnetic, optical or magnetic optical storage systems or any other available mass storage technology. Bus 118 may contain, for example, thirty-two address lines for addressing video memory 114 or main memory 115. The system bus 118 also includes, for example, a 32-bit data bus for transferring data between and among the components, such as processor 113, main memory 115, video memory 114 and mass storage 112. Alternatively, multiplex data/address lines may be used instead of separate data and address lines.

In one embodiment of the invention, the processor 113 is a microprocessor manufactured by Motorola, such as the 680X0 processor or a microprocessor manufactured by Intel, such as the 80X86, or Pentium processor, or a SPARC™ microprocessor from Sun Microsystems™, Inc. However, any other suitable microprocessor or microcomputer may be utilized. Main memory 115 is comprised of dynamic random access memory (DRAM). Video memory 114 is a dual-ported video random access memory. One port of the video memory 114 is coupled to video amplifier 116. The video amplifier 116 is used to drive the cathode ray tube (CRT) raster monitor 117. Video amplifier 116 is well known in the art and may be implemented by any suitable apparatus. This circuitry converts pixel data stored in video memory 114 to a raster signal suitable for use by monitor 117. Monitor 117 is a type of monitor suitable for displaying graphic images.

Computer 100 may also include a communication interface 120 coupled to bus 118. Communication interface 120 provides a two-way data communication coupling via a network link 121 to a local network 122. For example, if communication interface 120 is an integrated services digital network (ISDN) card or a modem, communication interface 120 provides a data communication connection to the corresponding type of telephone line, which comprises part of network link 121. If communication interface 120 is a local area network (LAN) card, communication interface 120 provides a data communication connection via network link 121 to a compatible LAN. Wireless links are also possible. In any such implementation, communication interface 120 sends and receives electrical, electromagnetic or optical signals which carry digital data streams representing various types of information.

Network link 121 typically provides data communication through one or more networks to other data devices. For example, network link 121 may provide a connection through local network 122 to local server computer 123 or to data equipment operated by an Internet Service Provider (ISP) 124. ISP 124 in turn provides data communication services through the world wide packet data communication network now commonly referred to as the “Internet” 125. Local network 122 and Internet 125 both use electrical, electromagnetic or optical signals which carry digital data streams. The signals through the various networks and the signals on network link 121 and through communication interface 120, which carry the digital data to and from computer 100, are exemplary forms of carrier waves transporting the information.

Computer 100 can send messages and receive data, including program code, through the network(s), network link 121, and communication interface 120. In the Internet example, remote server computer 126 might transmit a requested code for an application program through Internet 125, ISP 124, local network 122 and communication interface 120.

The received code may be executed by processor 113 as it is received, and/or stored in mass storage 112, or other non-volatile storage for later execution. In this manner, computer 100 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

### Bi-Directional Content Creation

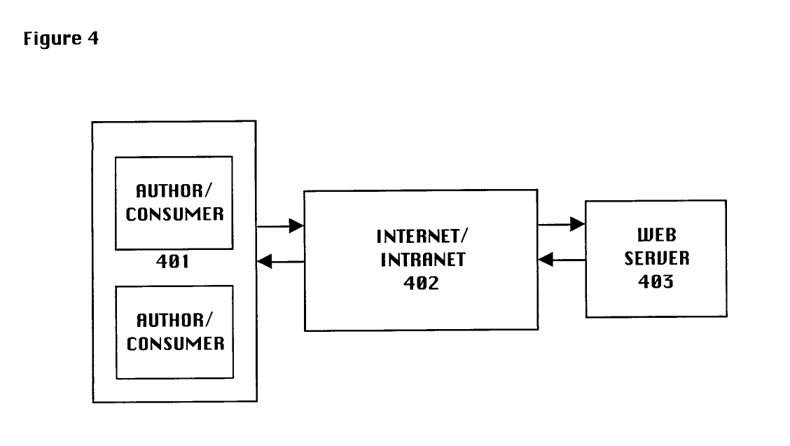

The present invention provides the ability to have bi-directional content creation. Consider the case where a user is reading a web page document. The invention permits that user to contribute to that web document by adding new material or editing the data that is already part of the document. FIG. 4 illustrates the topology of the web and the author/consumer relationship using the present invention. With the invention, the author and consumer 401 are in the same relationship. Both communicate for reading or writing to a web server 403 through the internet/intranet 402.

The invention provides the ability to perform document creation and editing within a browser context. In addition, the invention presents all the data to the user in a rich content format. The process steps for content creation include authorization, creation/editing, approval, and publishing.

### Authorization

In the present invention, authorization for content creation is via a log-in procedure. Authentication requires a login with password or security certificate when accessing a server. For some web sites, the ability to create, edit, or publish documents may be limited to authorized users. In other embodiments, it may be desired for any user or consumer be able to contribute to the site content. In those cases a “guest” log-in identification may be provided, or login might not be required at all.

The authentication process of the invention requires a user and group directory on the server to store login names and passwords or security certificates. The present invention can interface directly with a security directory in products such as Windows NT, eliminating the need to maintain another directory system. Alternatively, an interface to any LDAP directory system can be used, which will be able to interface to Lotus Notes, Novell NDS, Netscape, and other products that include LDAP support.

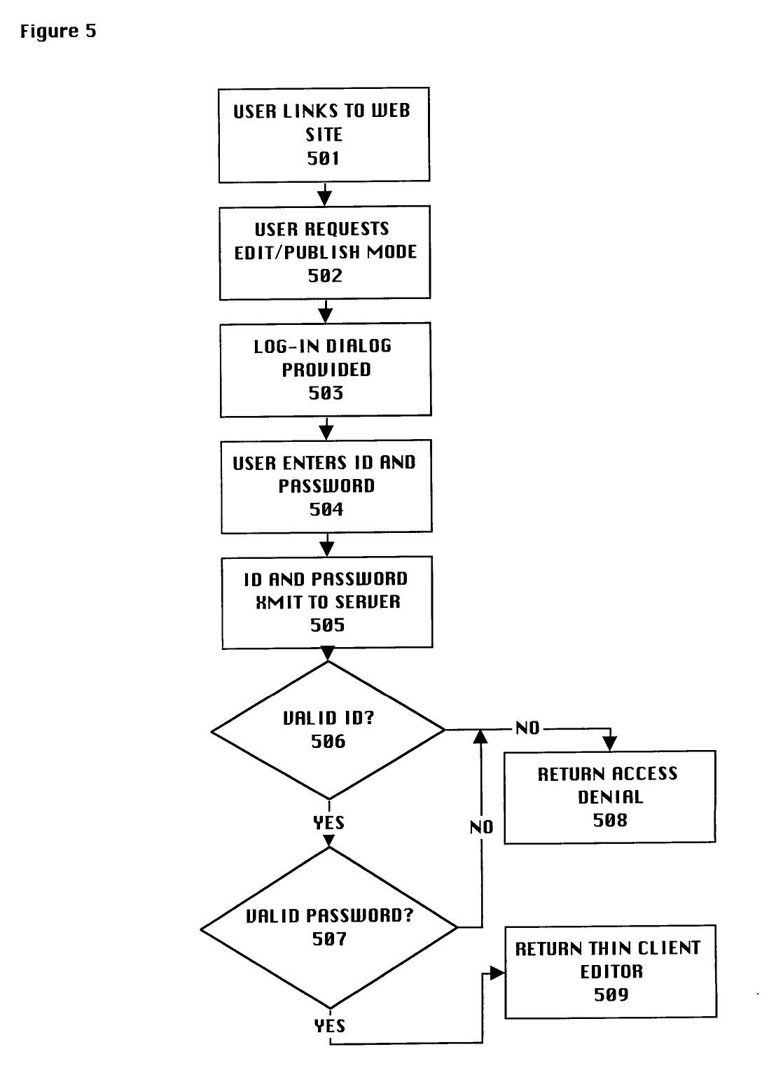

FIG. 5 is a flow diagram of a log-in procedure for a restricted access web site. At step 501 a user links to a web site. If the user wishes to enter the edit/publish mode at that web site, the user requests permission by invoking a link on the page (e.g. an “edit” link or button) at step 502. A log-in dialog box is then presented to the user at step 503 with prompts for a user ID and a password. The user enters ID and password at step 504, which is then transmitted to the web server for that page at step 505.

At decision block 506 the argument “Valid ID?” is made. If the argument is false, meaning that the ID is not valid, the server returns an access denial at step 508. This denial may take the form of a notice of an invalid ID and/or password, and may have a prompt for re-entry. If the argument at decision block 506 is true, the server proceeds to decision block 507. At decision block 507 the argument “Valid Password?” is made. If the argument is false, meaning an incorrect or invalid password, the server returns the access denial at step 508. If the argument is true, the server returns a “thin client” editor at step 509.

The thin client editor refers to a downloadable application that is normally resident at the server and is provided to the client/user only when requested. This provides an advantage over the prior art requirement of a fat client permanently resident on the client computer. Alternatively the editor may reside on the client computer and be enabled by the authorization log-in procedure. The thin client editor is capable of rendering HTML and of editing HTML. In one embodiment, a user can graphically edit the rendered web page. The HTML code for the page is available and is updated as the web page is edited. Alternately, the user can edit the HTML code itself if desire, with changes appearing on the rendered web page in the editor.

### Creation/Editing

Once a user is authorized to create or edit content, the user may invoke tools of the invention to create or edit content on the page. In one embodiment of the invention, the tool is a thin client HTML editor. The editor may be a thin client editor that is provided as a Java™ programming language applet, or it may reside on each user's computer. The HTML editor provides the ability to perform richly formatted text editing, such as italics, bold, centered, underline, tables, links, inserting graphics, etc. The invention shows the user content and editing as it occurs in a WYSIWYG mode, as well as automatically creating HTML tags that are associated with the rich formatting. The user can choose between editing in a WYSIWYG browser emulation display, or an HTML code level where HTML tags are directly editable.

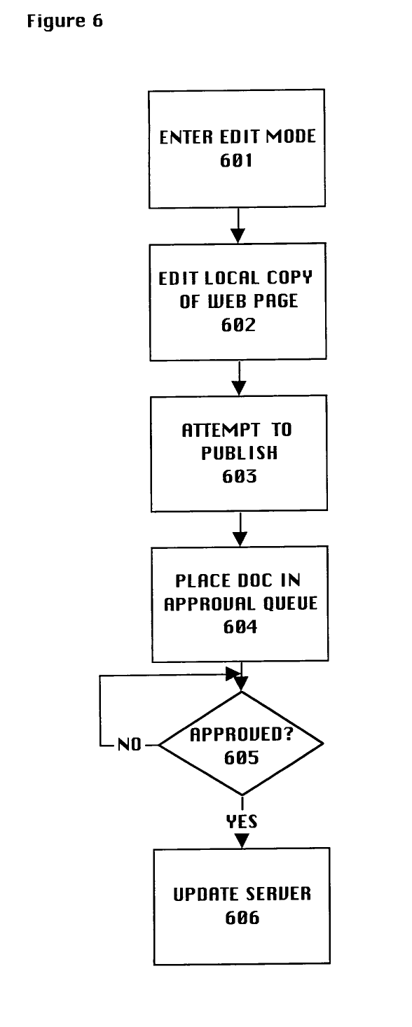

The editing of a web page is illustrated in the flow diagram of FIG. 6. At step 601 the user enters the edit mode. This brings an editing window with a copy of the web page of interest. (The user can move freely back and forth between the edit window and the browser window during editing mode). At step 602 the user edits the local copy of the web page. At step 603 the user attempts to publish the web page (in other words, to commit the changes to the web page server). At step 604 the edited document is placed in an approval queue. In the approval queue the argument “Approved?” is made at step 605. If the argument is true, the web server is updated with the changes at step 606. If the argument is false, the changes are not updated at the web server. At the user end, the user does not see the changes to the actual browser page until the user requests a refresh or update of the web page. If the user requests a refresh of an unapproved web page, the original web page will be presented.

During editing, the user may import local images from a local client source, such as a persistent storage device, or even from other web sites.

The invention uses a web page database that permits the user to edit in an environment that makes sense to the user. To the user, graphics and other images in a web page appear to be stored inside the rich text field in which they are used. However, in reality, the nature of an HTML document does not permit this, and requires that the graphics are stored outside the page and referenced via separate URLs.

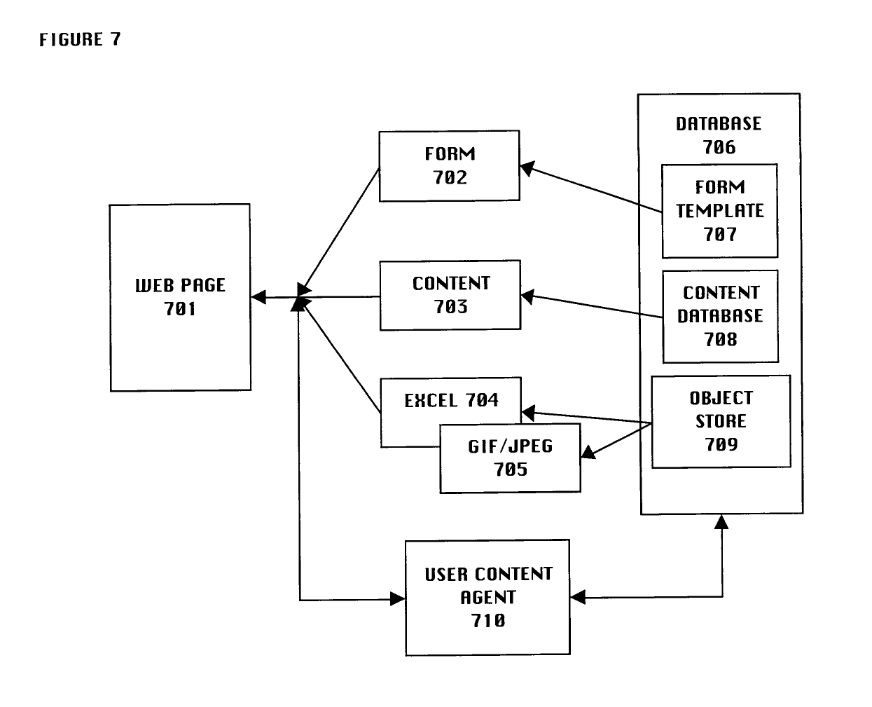

By contrast, the present invention permits the user to insert graphics into a rich text environment and treat them as if they were stored in the field itself. However, the present invention stores the graphics in a separate database and provides all necessary links for the graphics. The operation of this separate storage is transparent to the user. An example of the database used in one embodiment of the present invention is illustrated in FIG. 7.

Referring to FIG. 7, a web page 701 consists of a form with text and database content, and associated graphics. In the invention, the form data 702, database content 703, and graphics and other inserts such as Excel file 704 and image file 705, are stored separately in a database and combined dynamically to form the web page. Database 706 includes form template data 707, content database 708, and object store 709. In effect the database stores HTML information and stores other data as an attachment to the HTML, (such as the graphics and excel data of the object store database 709).

The invention uses a component referred to as a “user content agent” 710 to manage the generation of web page 701 from the components as well as some maintenance of the database 706. In traditional HTTP implementations, browsers provide URLs and expect to get web pages back. When a web page is created, the user content agent creates a URL for the page. When a browser calls the URL, the user content agent interprets the request and retrieves and builds the appropriate web page for delivery to the browser. The user content agent uses the URL to access a row in a database table. The table includes a field for URLs and a field for page content. Thus, instead of using a URL to point to a file on a server, the URL represents a row in a database table.

### Approval

Using the approval queue of the present invention, an approval cycle of edit, approve, publish can be invoked. The approval part of the cycle may configured to require manual sign off by one or more authorized web masters or other nominated personnel. Alternatively, the approval may be made by some automated algorithm.

### Publishing

Once editing or creation is completed, the web page is published. This is accomplished by updating the server containing the web page. Once the server is updated, browsers newly accessing the page, or refreshing their view of the page, are presented with the edited document.

### Dynamic Creation and Updating of Navigation Links

If a new document is added to the site, users will not be able to easily find that document unless there are navigation links added to the site. The invention allows links to be both dynamically added and updated on a site by using category information such as document title, author, and date which can be stored with each document. A database query is performed and the results of that query used to dynamically create links in a navigation page. As an example a newspaper web site could have a page that automatically listed all of today's news stories by querying the database for records with today's date. Furthermore these stories could be categorized so that only links to today's sports stories showed up on the sports page, for example.

Thus, a method and apparatus for providing content creation and management has been described.

1. A method of editing a web page comprising the steps of:
displaying said web page in a browser, said web page provided from a web server;
invoking an editing mode in said browser;
receiving an editing application from said web server for editing said page;
using said editing application to edit said web page to create an edited web page;
updating said web server with said edited web page.

2. The method of claim 1 wherein said editing application is a browser independent executable application.

3. The method of claim 1 further including the steps of:
initiating an authorization process for a user before said web page may be edited;
determining if authorization parameters have been satisfied;
providing authorization for said user to edit said web page.

4. The method of claim 3 wherein said authorization parameters comprise a valid user identification and password.

5. The method of claim 1 further including the steps of:
storing said edited web page in an approval queue prior to updating said web server with said edited web page;
determining if said edited web page is approved for publishing;
updating said web server with said edited web page when said edited web page has been approved for publishing.

6. The method of claim 1 wherein said web page is stored in a database and is comprised of and HTML portion and an attachment portion.

7. The method of claim 6 wherein said attachment portion comprises a graphic file.

8. The method of claim 1 wherein the web page may be one field in a database record, and where the database record may be edited in a browser with the web page being edited in an HTML editing region in the form.

9. The method of claim 1 wherein the web page may have two classes of attributes associated with the document, a first class of attributes including data such as the creator of a document or portion of document, the approver of a document and date of approval, and a second class of attributes including subject, category, and other data used to provide navigation links and indexing of data.

10. The method of claim 1 wherein links to help navigate to said web page are updated, added, or deleted on a navigation page automatically when a document is updated, added or deleted.

11. The method of claim 1 where as changes are made to said web page creating a new version of said web page, each version is stored in a version tracking store to maintain a history of changes.
